(19) United States
(12) Patent Application Publication
(10) Pub. No.: US 2010/0172011 A1
(43) Pub. Date: Jul. 8, 2010

(54) SEMI-ELECTROACTIVE MATERIAL CONTAINING ORGANIC COMPOUNDS HAVING POSITIVE OR NEGATIVE REDOX ACTIVITY, PROCESS AND KIT FOR MANUFACTURING THIS MATERIAL, ELECTRICALLY CONTROLLABLE DEVICE AND GLAZING UNITS USING SUCH A SEMI-ELECTROACTIVE MATERIAL

(75) Inventors: Fabienne Piroux, La Plaine Saint Denis (FR); Gilles Bokobza, Paris (FR); Pascal Petit, Gagny (FR); Jean-Christophe Giron, Eupen (BE)

Correspondence Address: OBLON, SPIVAK, MCCLELLAND MAIER & NEUSTADT, L.L.P., 1940 DUKE STREET, ALEXANDRIA, VA, 22314, US

(73) Assignee: SAINT-GOBAIN GLASS FRANCE, Courbevoie (FR)

(21) Appl. No.: 12/666,334

(22) PCT Filed: Jun. 25, 2008
(86) PCT No.: PCT/FR08/51161

§ 371 Date: Dec. 23, 2009

(30) Foreign Application Priority Data
Jun. 25, 2007 (FR) 0755987

(51) Int. Cl. G02F 1/153; H01B 1/12; H01B 1/22; B32B 27/00; B32B 7/02; B29C 67/20; B32B 37/10; B32B 37/00

(52) U.S. Cl. 359/268; 359/275; 252/500; 252/519.2; 252/519.33; 428/411.1; 428/212; 264/49; 156/219; 156/308.2; 977/700; 977/773

(57) ABSTRACT

This semi-electroactive material comprises a self-supporting polymer matrix, inserted into which is an electroactive system comprising or constituted by:
at least one electroactive organic compound capable of being oxidized and/or of ejecting electrons and cations acting as compensation charges; or
at least one electroactive organic compound capable of being reduced and/or of accepting electrons and cations acting as compensation charges; and
ionic charges;
   and also a solubilization liquid for said semi-electroactive system, said liquid not dissolving said self-supporting polymer matrix, the latter being chosen to provide a percolation pathway for ionic charges, this allowing, under the action of a dielectric current, oxidation and reduction reactions of said electroactive organic compounds, which reactions are necessary to obtain a color contrast.

The present invention relates to an electroactive material, also known as a semi-electroactive material, for an electrically controllable device said to have variable optical and/or energy properties, said semi-electroactive material containing organic compounds having a positive or negative redox activity, to a process and a kit for manufacturing this material, to an electrically controllable device comprising a self-supporting layer of polymer having complementary redox activity, namely that is respectively negative or positive, and to glazing units using such a semi-electroactive material.

In what follows, the electroactive material (or system) of the invention is sometimes also denoted by semi-electroactive material (or system), touching on the fact that this material (or system) is capable of forming an electrochemical half-cell.

Such a device may be defined in a general manner as comprising the following stack of layers:
a first substrate having a glass function;
a first electronically conductive layer with an associated current feed;
an electroactive system;
a second electronically conductive layer with an associated current feed; and
a second substrate having a glass function.

The known layered electroactive systems comprise two layers of electroactive material separated by an electrolyte, the electroactive material of at least one of the two layers being electrochromic. In the case where both electroactive materials are electrochromic materials, these may be identical or different. In the case where one of the electroactive materials is electrochromic and the other is not, the latter will have the role of a counterelectrode that does not participate in the coloring and bleaching processes of the system. Under the action of an electric current, the ionic charges of the electrolyte are inserted into one of the layers of electrochromic material and are ejected from the other layer of electrochromic material or counterelectrode to obtain a color contrast.

As a common example of an electroactive system having layers and a polymer, mention may be made of the following stack of layers:
poly(3,4-ethylenedioxythiophene) (PEDOT);
electrolyte;
poly(3,4-ethylenedioxythiophene) (PEDOT).

Such electroactive systems are not always satisfactory;

in particular they require a relatively high voltage (greater than 2 V) to obtain an acceptable color contrast for the commercial exploitation of the electrically controllable device.

Known electroactive systems having electroactive organic compounds comprise an active medium composed of a solvent in which at least two electroactive organic compounds are dissolved, one being an electrochromic material and the other being a counterelectrode material which may itself also be electrochromic. In order to solidify the active medium, a polymer may be used as a thickening agent. Such systems operate by oxidation and reduction reactions of the electroactive compounds. A salt may also be added to facilitate the transport of the charges and the redox reactions.

Such systems make it possible to obtain quite high contrasts with a relatively low voltage (below 2 V), especially in the case where the electroactive compounds are electrochromic with complementary colors. On the other hand, the active medium is in liquid or gelled form which may result in optically unacceptable phase segregation phenomena.

The applicant company has sought a solution to these problems, and has on this occasion discovered a novel hybrid polymer/organic electroactive system structure which allows a coloration at a low voltage (below 2 V). Such a reduction in the coloration voltage has the effect of increasing the durability of the electrically controllable device, the electroactive medium and also the electronically conductive layers of this device being less electrochemically stressed. Furthermore, since one of the electroactive compounds is in the form of a polymer layer, the segregation phenomena are avoided.

An electrochromic device is known from international Application PCT WO 96/13754 and Patent U.S. Pat. No. 6,178,034 B1, that comprises a conductive electrode and a conductive counterelectrode, arranged between which are:
an inorganic or polymer electrochemically active layer, which is negative, that is to say which may be reduced and/or accept electrons and cations acting as compensation charges, such as a layer of tungsten oxide, of polyviologen or of polythiophene such as PEDOT, or which is positive, that is to say which may be oxidized and/or eject electrons and cations acting as compensation charges, such as a layer of nickel oxide or of polyaniline; and
an electrolyte containing at least one redox active material which may be a positive redox active material such as a metallocene, or a negative redox active material such as a viologen, depending on whether the electrochemically active polymer layer is negative or positive.

However, it appears that the combination of a polythiophene such as PEDOT with a viologen in the electrolyte as mentioned in U.S. Pat. No. 6,178,034 B1 does not give any color contrast under the action of an electric current.

Also known from U.S. Pat. No. 6,178,034 B1 are systems of the aforementioned type comprising an electrochromic polymer layer and an electrolytic layer containing an organic, non-polymeric electrochromic compound. Lists of these polymers and of these compounds are presented in this document but without a description of any need to combine components having complementary coloration.

One subject of the present invention is therefore a semi-electroactive material of an electrically controllable device having variable optical/energy properties, characterized in that it comprises a self-supporting polymer matrix, inserted into which is an electroactive system comprising or constituted by:
at least one electroactive organic compound capable of being oxidized and/or of ejecting electrons and cations acting as compensation charges; or
at least one electroactive organic compound capable of being reduced and/or of accepting electrons and cations acting as compensation charges; and
ionic charges;
   and also a solubilization liquid for said semi-electroactive system, said liquid not dissolving said self-supporting polymer matrix, the latter being chosen to provide a percolation pathway for ionic charges, this allowing, under the action of a dielectric current, oxidation and reduction reactions of said electroactive organic compounds, which reactions are necessary to obtain a color contrast.

The expression “cations acting as compensation charges” is understood to mean the Li⁺, H⁺, etc. ions which may be inserted into or ejected from the electroactive compounds at the same time as the electrons.

The expression “electroactive organic compound capable of being oxidized and/or of ejecting electrons and cations acting as compensation charges” is understood to mean a compound having a positive redox activity, which may be an electrochrome with anodic coloration or a non-electrochromic compound, then only acting as an ionic charge reservoir or a counterelectrode.

The expression “electroactive organic compound capable of being reduced and/or of accepting electrons and cations acting as compensation charges”, is understood to mean a compound having a negative redox activity, which may be an electrochrome with cathodic coloration or a non-electrochromic compound, then acting only as an ionic charge reservoir or a counterelectrode.

The ionic charges may be carried by the electroactive organic compound or compounds and/or by at least one ionic salt and/or at least one acid dissolved in said liquid and/or by said self-supporting polymer matrix.

The solubilization liquid may be made up of a solvent or a mixture of solvents and/or of at least one ionic liquid or ambient-temperature molten salt, said ionic liquid(s) or molten salt(s) then constituting a solubilization liquid bearing ionic charges, which represent all or some of the ionic charges of said semi-electroactive system.

The electroactive organic compound or compounds capable of being reduced and/or of accepting electrons and cations acting as compensation charges may be chosen from bipyridiniums or viologens such as 1,1′-diethyl-4,4′-bipyridinium diperchlorate, pyraziniums, pyrimidiniums, quinoxaliniums, pyryliums, pyridiniums, tetrazoliums, verdazyls, quinones, quinodimethanes, tricyanovinylbenzenes, tetracyanoethylene, polysulfides and disulfides, and also all the electroactive polymer derivatives of the electroactive compounds which have just been mentioned. As examples of the above polymer derivatives, mention may be made of polyviologens.

The electroactive organic compound or compounds capable of being oxidized and/or of ejecting electrons and cations acting as compensation charges may be chosen from metallocenes, such as cobaltocenes, ferrocenes, N,N,N′,N′-tetramethylphenylenediamine (TMPD), phenothiazines such as phenothiazine, dihydrophenazines such as 5,10-dihydro-5,10-dimethylphenazine, reduced methylphenothiazone (MPT), methylene violet bernthsen (MVB), verdazyls, and also all the electroactive polymer derivatives of the electroactive compounds which have just been mentioned.

The ionic salt or salts may be chosen from lithium perchlorate, trifluoromethanesulfonate or triflate salts, trifluoromethanesulfonylimide salts and ammonium salts.

The acid or acids may be chosen from sulfuric acid (H₂SO₄), triflic acid (CF₃SO₃H), phosphoric acid (H₃PO₄) and polyphosphoric acid (Hₙ₊₂PₙO₃ₙ₊₁). The concentration of the ionic salt or salts and/or of the acid or acids in the solvent or the mixture of solvents is especially less than or equal to 5 mol/l, preferably less than or equal to 2 mol/l, even more preferably less than or equal to 1 mol/l.

The or each solvent may be chosen from those having a boiling point at least equal to 95° C., preferably at least equal to 150° C.

The solvent or solvents may be chosen from dimethylsulfoxide, N,N-dimethylformamide, N,N-dimethyl-acetamide, propylene carbonate, ethylene carbonate, N-methyl-2-pyrrolidone (1-methyl-2-pyrrolidinone), γ-butyrolactone, ethylene glycols, alcohols, ketones, nitriles and water.

The ionic liquid or liquids may be chosen from imidazolium salts, such as 1-ethyl-3-methylimidazolium tetrafluoroborate (emim-BF₄), 1-ethyl-3-methyl-imidazolium trifluoromethane sulfonate (emim-CF₃SO₃), 1-ethyl-3-methylimidazolium bis(trifluoromethyl-sulfonyl)imide (emim-N(CF₃SO₂)₂ or emim-TSFI) and 1-butyl-3-methylimidazolium bis(trifluoromethyl-sulfonyl)imide (bmim-N(CF₃SO₂)₂ or bmim-TSFI).

The self-supporting polymer matrix may be composed of at least one polymer layer in which said liquid has penetrated to the core.

The polymer or polymers of the matrix and the liquid may be chosen so that the self-supporting active medium withstands a temperature corresponding to the temperature necessary for a subsequent laminating or calendering step, namely a temperature of at least 80° C., in particular of at least 100° C.

The polymer constituting at least one layer may be a homopolymer or copolymer that is in the form of a nonporous film but is capable of swelling in said liquid.

The film has, in particular, a thickness of less than 1 mm, preferably of 10 to 500 μm, more preferably of 50 to 120 μm.

The polymer constituting at least one layer may also be a homopolymer or copolymer that is in the form of a porous film, said porous film being optionally capable of swelling in the liquid comprising ionic charges and of which the porosity after swelling is chosen to allow the percolation of ionic charges in the thickness of the liquid-impregnated film.

Said film then has, in particular, a thickness of less than 1 mm, preferably less than 800 μm, more preferably of 10 to 500 μm, and more preferably still of 50 to 120 μm.

Furthermore, the polymer or polymers of the polymer matrix are advantageously chosen in order to be able to withstand the conditions of laminating and calendering, optionally with heating.

The polymer material constituting at least one layer may be chosen from:
homopolymers or copolymers that do not comprise ionic charges, in which case these charges are carried by the electroactive organic compound or compounds and/or by at least one ionic salt or dissolved acid and/or by at least one ionic liquid or molten salt;
homopolymers or copolymers comprising ionic charges, in which case supplementary charges that make it possible to increase the percolation rate may be carried by the electroactive organic compound or compounds and/or by at least one ionic salt or dissolved acid and/or by at least one ionic liquid or molten salt; and
blends of at least one homopolymer or copolymer that do not comprise ionic charges and of at least one homopolymer or copolymer comprising ionic charges, in which case supplementary charges that make it possible to increase the percolation rate may be carried by the electroactive organic compound or compounds and/or by at least one ionic salt or dissolved acid and/or by at least one ionic liquid or molten salt.

The polymer matrix may be made up of a film based on a homopolymer or copolymer comprising ionic charges, capable of giving, by itself, a film essentially capable of providing the desired percolation rate for the electroactive system or a percolation rate greater than this and on a homopolymer or copolymer that may or may not comprise ionic charges, capable of giving, by itself, a film that does not necessarily make it possible to provide the desired percolation rate, but that is essentially capable of ensuring the mechanical behavior, the contents of each of these two homopolymers or copolymers being adjusted so that both the desired percolation rate and the mechanical behavior of the resulting self-supporting organic active medium are ensured.

The polymer or polymers of the polymer matrix that do not comprise ionic charges may be chosen from copolymers of ethylene, of vinyl acetate and optionally of at least one other comonomer, such as ethylene/vinyl acetate copolymers (EVA); polyurethane (PU); polyvinyl butyral (PVB); polyimides (PI); polyamides (PA);

polystyrene (PS); polyvinylidene fluoride (PVDF); polyetheretherketones (PEEK); polyethylene oxide (POE); epichlorohydrin copolymers and polymethyl methacrylate (PMMA).

The polymers are chosen from the same family whether they are prepared in the form of porous or nonporous films, the porosity being provided by the pore-forming agent used during the manufacture of the film.

As polymers that are preferred in the case of the nonporous film, mention may be made of polyurethane (PU) or ethylene/vinyl acetate copolymers (EVA).

As polymers that are preferred in the case of the porous film, mention may be made of polyvinylidene fluoride.

The polymer or polymers of the polymer matrix bearing ionic charges or polyelectrolytes may be chosen from sulfonated polymers which have undergone an exchange of the H⁺ ions of the SO₃H groups with the ions of the desired ionic charges, this ion exchange having taken place before and/or at the same time as the swelling of the polyelectrolyte in the liquid comprising ionic charges.

The sulfonated polymer may be chosen from sulfonated copolymers of tetrafluoroethylene, polystyrene sulfonates (PSS), copolymers of sulfonated polystyrene, poly(2-acrylamido-2-methyl-1-propanesulfonic acid) (PAMPS), sulfonated polyetheretherketones (PEEK) and sulfonated polyimides.

The support may comprise from one to three layers.

When the support comprises at least two layers, a stack of at least two layers may have been formed from electrolyte and/or non-electrolyte polymer layers before penetration of the liquid to the core, then has been swollen by said liquid.

When the support comprises three layers, the two outer layers of the stack may be layers having low swelling in order to favor the mechanical behavior of said material and the central layer is a layer having high swelling to favor the percolation rate of the ionic charges.

The self-supporting polymer matrix may be nanostructured by the incorporation of nanoparticles of fillers or inorganic nanoparticles, in particular SiO₂ nano-particles, especially in an amount of a few percent relative to the mass of polymer in the support. This makes it possible to improve certain properties of said support such as the mechanical strength.

Another subject of the present invention is a process for manufacturing a semi-electroactive material as defined above, characterized in that polymer granules are mixed with a solvent and, if it is desired to manufacture a porous polymer matrix, a pore-forming agent, the resulting formulation is cast on a support and after evaporation of the solvent, the pore-forming agent is removed by washing in a suitable solvent for example if this agent has not been removed during the evaporation of the aforementioned solvent, the resulting self-supporting film is removed, then said film is impregnated with the solubilization liquid of the semi-electroactive system, and then a draining operation is carried out, where appropriate.

The immersion can then be carried out for a time period of 2 minutes to 3 hours. The immersion can be carried out with heating, for example at a temperature of 40 to 80° C.

It is also possible to carry out the immersion with the application of ultrasounds to aid the penetration of the solubilization liquid into the matrix.

Equally, another subject of the present invention is a kit for manufacturing the semi-electroactive material as defined above, characterized in that it consists of:
a self-supporting polymer matrix as defined above; and
a solubilization liquid of the semi-electroactive system as defined above, in which said semi-electroactive system has been dissolved.

Another subject of the present invention is an electrically controllable device comprising the following stack of layers:
a first substrate having a glass function;
a first electronically conductive layer with an associated current feed;
an electroactive system;
a second electronically conductive layer with an associated current feed; and
a second substrate having a glass function, characterized in that the electroactive system is composed of the following stack of layers:
a semi-electroactive material as defined above; and
a self-supporting layer of at least one electroactive polymer capable of being reduced and/or of accepting electrons and cations acting as compensation charges when the semi-electroactive material contains at least one electroactive organic compound capable of being oxidized and/or of ejecting electrons and cations acting as compensation charges, or conversely of at least one electroactive polymer capable of being oxidized and/or of ejecting electrons and cations acting as compensation charges when the semi-electroactive material contains at least one electroactive organic compound capable of being reduced and/or of accepting electrons and cations acting as compensation charges,
   at least one of the electroactive compounds of the semi-electroactive medium and electroactive polymers of the self-supporting layer being electrochromic in order to obtain a color contrast,
   the ionic charges of said semi-electroactive material, under the action of an electric current, making it possible to reduce and/or to insert electrons and cations or else to oxidize and/or to eject electrons and cations in the aforementioned electroactive polymer layer and the electroactive organic compound of the semi-electroactive medium being oxidized or reduced to obtain a color contrast.

The cations acting as compensation charges may also be inserted into or ejected from the electroactive polymers of the self-supporting layer.

The substrates having a glass function are especially chosen from glass (float glass, etc.) and transparent polymers, such as polymethyl methacrylate (PMMA), polycarbonate (PC), polyethylene terephthalate (PET), polyethylene naphthoate (PEN) and cycloolefin copolymers (COCs).

The electronically conductive layers are especially layers of metallic type, such as layers of silver, of gold, of platinum and of copper; or layers of transparent conductive oxide (TCO) type, such as layers of tin-doped indium oxide (In₂O₃:Sn or ITO), of antimony-doped indium oxide (In₂O₃:Sb), of fluorine-doped tin oxide (SnO₂:F) and of aluminum-doped zinc oxide (ZnO:Al); or multilayers of the TCO/metal/TCO type, the TCO and the metal being especially chosen from those listed above; or multilayers of the NiCr/metal/NiCr type, the metal especially being chosen from those listed above.

When the electrochromic system is intended to work in transmission, the electrically conductive materials are generally transparent oxides for which the electronic conduction has been amplified by doping, such as In₂O₃:Sn, In₂O₃:Sb, ZnO:Al or SnO₂:F. Tin-doped indium oxide (In₂O₃:Sn or ITO) is frequently used for its high electronic conductivity properties and its low light absorption. When the system is intended to work in reflection, one of the electrically conductive materials may be of metallic nature.

The polymer capable of being reduced and/or of accepting electrons and cations acting as compensation charges is especially chosen from polyviologens, polymers containing bipyridinium, pyrylium, pyrazinium or quinoxalium units or groups, polyarylenes and polyheteroarylenes such as polythiophenes, for example poly(3,4-ethylenedioxythiophene) (PEDOT), poly[3,3-di-methyl-3,4-dihydro-2H-thieno-(3,4-b)dioxepine] (ProDOT-Me₂), poly(isothianophthene), polyisothianaphthene (PITN), polyimides, polyquinones and polydisulfides.

The polymer capable of being oxidized and/or of ejecting electrons and cations acting as compensation charges is especially chosen from polyarylamines, such as polyanilines, polyarylenes, such as polyphenylenes or polyfluorenes, polyheteroarylenes such as polypyrroles, for example poly(N-sulfonatopropoxy-3,4-propylenedioxy-pyrrole) (PProDOP-NPrS), polyindoles, copolymers of thiophene such as poly(octanoic acid 2-thiophen-3-yl-ethyl ester) (POTE), poly[decanedioic acidbis(2-thio-phen-3-ylethyl)ester] (PDATE), poly{2-[(3-thienyl-carbonyl)oxy]ethyl 3-thiophene carboxylate} (PTOET), poly{2,3-bis[(3-thienylcarbonyl)oxy]propyl 3-thiophene carboxylate} (PTOPT), poly{3-[(3-thienylcarbonyl)oxy]-2,2-bis[(3-thienylcarbonyl)oxy]propyl 3-thiophene carboxylate} (PTOTPT), poly[3,6-bis(2-ethylenedioxy-thienyl)-N-methylcarbazole] (PBEDOT-NMeCz), polyarylenevinylenes such as poly(para-phenylene vinylenes) (PPV), polyheteroarylenevinylenes and polymers containing ferrocene units or groups.

The electrically controllable device of the present invention is especially configured to form:
a sunroof for a motor vehicle, that can be activated autonomously, or a side window or a rear window for a motor vehicle or a rear-view mirror;
a windshield or a portion of a windshield of a motor vehicle, of an aircraft, of a ship, a vehicle sunroof;
an aircraft cabin window;
a display panel for displaying graphical and/or alphanumeric information;
an interior or exterior glazing unit for buildings;
a skylight;
a display cabinet or store counter;
a glazing unit for protecting objects of the painting type;
an anti-glare computer screen;
glass furniture; and
a wall for separating two rooms inside a building.

The electrically controllable device may operate in transmission or in reflection.

The substrates may be transparent, flat or curved, clear or bulk-tinted, opaque or opacified, of polygonal shape or at least partially curved. At least one of the substrates may incorporate another functionality such as a solar control, antireflection or self-cleaning functionality.

The present invention also relates to a process for manufacturing the electrically controllable device as defined above, characterized in that the various layers which form it are assembled by calendering or laminating, optionally with heating.

In the case where the electrically controllable device is intended to form a glazing unit, the above process also comprises the assembly of the various layers as a single or multiple glazing unit.

The following examples illustrate the present invention without however limiting the scope thereof. In these examples, the following abbreviations have been used:

PEDOT/PSS: poly(3,4-ethylenedioxythiophene)/polystyrene sulfonate sold under the name Baytron® P by HC Stark.

PVDF: polyvinylidene fluoride

In these examples, the deposition was carried out of wet formulations of PEDOT/PSS (Baytron® P) following the formulation guide CPP 105D from HC Stark.

The glass used in these examples is a glass equipped with an electrically conductive layer of SnO₂:F, sold under the name K-glass™ by Pilkington.

In order to prepare the PVDF films, polyvinylidene fluoride powders manufactured by Arkema under the name Kynar® 2501 or 2821 were used.

### EXAMPLE 1

### Manufacture of an Electrochromic Device

glass having a layer of SnO₂:F coated with a layer of PEDOT/PSS;
semi-electroactive system: ferrocene+lithium perchlorate+propylene carbonate; and
glass having a layer of SnO₂:F.

An electrochromic device was manufactured using a sheet of bare K-glass and a sheet of K-glass onto which a layer of PEDOT/PSS had been deposited (wet deposition of 360 microns). Before assembling, the layer of PEDOT/PSS was reduced in a solution of acetonitrile and lithium perchlorate at a concentration of 1M.

A self-supporting film of PVDF was manufactured by mixing 3.5 g of PVDF (Kynar® 2501), 6.5 g of dibutyl phthalate and 12 g of acetone. The formulation was stirred for two hours, and it was cast on a sheet of glass. After evaporation of the solvent, the PVDF film was removed from the glass sheet under a trickle of water.

A semi-electroactive solution was prepared by mixing 0.23 g of ferrocene and 0.27 g of lithium perchlorate in 40 ml of propylene carbonate. The solution was stirred for 1 hour.

The self-supporting semi-electroactive medium was obtained by immersing the PVDF film having a thickness of around 80 microns in diethyl ether for 5 minutes, then in the semi-electroactive solution for 5 minutes. The PVDF film impregnated with semi-electroactive solution was then wiped between two absorbent papers before being deposited onto a sheet of bare K-glass. A frame made of double-sided adhesive was used as a seal and the sheet of K-glass covered with PEDOT/PSS was deposited on the semi-electroactive film to complete the electrochromic device.

The electrochromic device thus manufactured had a light transmission of 42% in the bleached state under a voltage of 1.5 V, and of 13.5% in the colored state under a voltage of −1.5 V. After 1000 bleaching and coloring cycles, the properties of the electrochromic device remained unchanged.

### EXAMPLE 2

### Manufacture of an Electrochromic Device

glass having a layer of SnO₂:F coated with a layer of PEDOT/PSS;
semi-electroactive system: ferrocene+lithium trifluoromethanesulfonate+propylene carbonate; and
glass having a layer of SnO₂:F.

An electrochromic device was manufactured using a sheet of bare K-glass and a sheet of K-glass onto which a layer of PEDOT/PSS had been deposited (wet deposition of 360 microns). Before assembling, the layer of PEDOT/PSS was reduced in a solution of acetonitrile and lithium perchlorate at a concentration of 1M.

A self-supporting film of PVDF was manufactured by mixing 3.5 g of PVDF (Kynar® 2821), 6.5 g of dibutyl phthalate and 12 g of acetone. The formulation was stirred for two hours, and it was cast on a sheet of glass. After evaporation of the solvent, the PVDF film was removed from the glass sheet under a trickle of water.

A semi-electroactive solution was prepared by mixing 0.23 g of ferrocene and 0.39 g of lithium trifluoromethanesulfonate in 40 ml of propylene carbonate. The solution was stirred for 1 hour.

The self-supporting semi-electroactive medium was obtained by immersing the PVDF film having a thickness of around 80 microns in diethyl ether for 5 minutes, then in the semi-electroactive solution for 5 minutes. The PVDF film impregnated with semi-electroactive solution was then wiped between two absorbent papers before being deposited onto a sheet of bare K-glass. A frame made of double-sided adhesive was used as a seal and the sheet of K-glass covered with PEDOT/PSS was deposited on the semi-electroactive film to complete the electrochromic device.

The electrochromic device thus manufactured had a light transmission of 45% in the bleached state under a voltage of 1.5 V, and of 15% in the colored state under a voltage of −1.5 V. After 100 bleaching and coloring cycles, the properties of the electrochromic device remained unchanged.

### COMPARATIVE EXAMPLE 3

### Preparation of an Electrochromic Device

glass having a layer of SnO₂:F coated with a layer of PEDOT/PSS;
electrolyte: lithium perchlorate+propylene carbonate; and
glass having a layer of SnO₂:F coated with a layer of PEDOT/PSS.

An electrochromic device was manufactured using two sheets of K-glass onto each of which a layer of PEDOT/PSS had been deposited (wet deposition of 180 microns). Before assembling, the PEDOT/PSS layers were reduced in a solution of acetonitrile and lithium perchlorate at a concentration of 1M.

A self-supporting film of PVDF was manufactured by mixing 3.5 g of PVDF (Kynar® 2821), 6.5 g of dibutyl phthalate and 12 g of acetone. The formulation was stirred for two hours, and it was cast on a sheet of glass. After evaporation of the solvent, the PVDF film was removed from the glass sheet under a trickle of water.

An electrolyte solution was prepared by dissolving 0.27 g of lithium perchlorate in 40 ml of propylene carbonate. The solution was stirred for 1 hour. The self-supporting electrolyte was obtained by immersing, for 5 minutes, the PVDF film having a thickness of around 80 microns in diethyl ether for 5 minutes then in the electrolyte solution for 5 minutes. The PVDF film impregnated with electrolyte solution was then wiped between two absorbent papers before being deposited onto one of the two sheets of K-glass covered with PEDOT/PSS. A frame made of double-sided adhesive was used as a seal and the second sheet of K-glass covered with PEDOT/PSS was deposited onto the self-supporting electrolyte film to complete the electrochromic device.

The electrochromic device thus manufactured had a light transmission of 18% in the bleached state under a voltage of 0 V, and of 10.5% in the colored state under a voltage of −2 V.

1. A semi-electroactive material of an electrically controllable device having variable optical/energy properties, comprising a self-supporting polymer matrix, inserted into which is an electroactive system comprising:
at least one electroactive organic compound capable of being oxidized or of ejecting electrons and cations acting as compensation charges, or both; or
at least one electroactive organic compound capable of being reduced or of accepting electrons and cations acting as compensation charges; and
ionic charges, or both;
and a solubilization liquid for said semi-electroactive system, said liquid not dissolving said self-supporting polymer matrix, the latter being chosen to provide a percolation pathway for ionic charges, this allowing, under the action of a dielectric current, oxidation and reduction reactions of said electroactive organic compounds, which reactions are necessary to obtain a color contrast.

2. The semi-electroactive material as claimed in claim 1, wherein the at least one electroactive organic compound capable of being reduced or of accepting electrons and cations acting as compensation charges, or both, is at least one bipyridinium or viologen selected from the group consisting of 1,1′diethyl-4,4′ bipyridinium diperchlorate, pyrazinium, pyrimidinium, quinoxalinium, pyrylium, pyridinium, tetrazolium, verdazyl, quinone, quinodimethane, tricyanovinylbenzene, tetracyanoethylene, polysulfide and disulfide, and also all the electroactive polymer derivatives of the electroactive compounds which have just been mentioned, and the at least one electroactive organic compound capable of being oxidized or of ejecting electrons and cations acting as compensation charges, or both, is at least one metallocene or phenothiazine selected from the group consisting of cobaltocene, ferrocene, N,N,N′,N′ tetramethylphenylenediamine (TMPD), dihydrophenazine, 5,10 dihydro-5,10 dimethylphenazine, reduced methylphenothiazone (MPT), methylene violet bernthsen (MVB), verdazyl, and also all the electroactive polymer derivatives of the electroactive compounds which have just been mentioned.

3. The semi-electroactive material as claimed in claim 1, wherein the ionic charges are borne by the electroactive organic compound or by at least one ionic salt or by at least one acid dissolved in said liquid, or by said self-supporting polymer matrix, wherein the ionic salt is at least one selected from the group consisting of lithium perchlorate, trifluoromethanesulfonate salt triflate, trifluoromethanesulfonylimide salt, and ammonium salt, and the acid is at least one selected from the group consisting of sulfuric acid (H₂SO₄), triflic acid (CF₃SO₃H), phosphoric acid (H₃PO₄) and polyphosphoric acid (Hₙ₊₂PₙO₃ₙ₊₁).

4. The semi-electroactive material as claimed in claim 1, wherein the solubilization liquid comprises at least one a solvent or at least one ionic liquid, or at least one ambient-temperature molten salt, or a mixture thereof, said ionic liquid or molten salt then constituting a solubilization liquid bearing ionic charges, which represent all or some of the ionic charges of said semi-electroactive system, wherein the solvent is at least one selected from the group consisting of dimethylsulfoxide, N,N dimethylformamide, N,N dimethylacetamide, propylene carbonate, ethylene carbonate, N methyl-2 pyrrolidone (1 methyl-2 pyrrolidinone), γy-butyrolactone, ethylene glycol, alcohol, ketone, nitrile and water, and the ionic liquid is at least one imidazolium salt selected from the group consisting of 1 ethyl-3 methylimidazolium tetrafluoroborate (emim BF₄), 1 ethyl-3 methylimidazolium trifluoromethane sulfonate (emim CF₃SO₃), 1 ethyl-3 methylimidazolium bis(trifluoromethylsulfonyl)imide (emim N(CF₃SO₂)₂ or emim TSFI) and 1 butyl-3 methylimidazolium bis(trifluoromethylsulfonyl)imide (bmim N(CF₃SO₂)₂ or bmim TS Fl).

5. The semi-electroactive material as claimed in claim 1, wherein the self-supporting polymer matrix comprises at least one polymer layer in which said liquid has penetrated to the core, the polymer comprising at least one layer being a homopolymer or copolymer that is in the form of a nonporous film but is capable of swelling in said liquid, or that is in the form of a porous film, said porous film optionally being capable of swelling in the liquid comprising ionic charges and of which the porosity after swelling is chosen to allow the percolation of the ionic charges into the thickness of the liquid-impregnated film.

6. The semi-electroactive material as claimed in claim 5, wherein the polymer material comprising at least one layer is chosen from:
a homopolymer or a copolymer that do not comprise ionic charges, in which case these charges are carried by the at least one electroactive organic compound or by at least one ionic salt or dissolved acid or by at least one ionic liquid or molten salt, or mixtures thereof;
a homopolymer or a copolymer comprising ionic charges, in which case supplementary charges that make it possible to increase the percolation rate may be carried by the at least one electroactive organic compound or by at least one ionic salt or dissolved acid or by at least one ionic liquid or molten salt, or mixtures thereof; and
a blend of at least one homopolymer or copolymer that do not comprise ionic charges and of at least one homopolymer or copolymer comprising ionic charges, in which case supplementary charges that make it possible to increase the percolation rate may be carried by the at least one electroactive organic compound or by at least one ionic salt or dissolved acid or by at least one ionic liquid or molten salt or mixtures thereof.

7. The semi-electroactive material as claimed in claim 1, wherein the polymer matrix is made up of a film based on a homopolymer or copolymer comprising ionic charges, capable of giving, by itself, a film essentially capable of providing the desired percolation rate for the electroactive system or a percolation rate greater than this and on a homopolymer or copolymer that may or may not comprise ionic charges, capable of giving, by itself, a film that does not necessarily make it possible to provide the desired percolation rate, but that is essentially capable of ensuring the mechanical behavior, the contents of each of these two homopolymers or copolymers being adjusted so that both the desired percolation rate and the mechanical behavior of the resulting self-supporting organic active medium are ensured.

8. The semi-electroactive material as claimed in claim 6, wherein the polymer of the polymer matrix that do not comprise ionic charges is at least one selected from the group consisting of copolymer of ethylene, copolymer of vinyl acetate, ethylene/vinyl acetate copolymer (EVA); polyurethane (PU); polyvinyl butyral (PVB); polyimide (PI); polyamide (PA); polystyrene (PS); polyvinylidene fluoride (PVDF); polyetheretherketones (PEEK); polyethylene oxide (POE); epichlorohydrin copolymer, and polymethyl methacrylate (PMMA), wherein the polymer of the polymer matrix bearing ionic charges or polyelectrolytes are chosen from sulfonated polymers which have undergone an exchange of the H+ ions of the SO₃H groups with the ions of the desired ionic charges, this ion exchange having taken place before or at the same time as the swelling of the polyelectrolyte in the liquid comprising ionic charges, or both, wherein the sulfonated polymer is selected from the group consisting of sulfonated copolymer of tetrafluoroethylene, polystyrene sulfonate (PSS), copolymer of sulfonated polystyrene, poly(2 acrylamido-2 methyl-1 propanesulfonic acid) (PAMPS), sulfonated polyetheretherketone (PEEK) and sulfonated polyimide.

9. The semi-electroactive material as claimed in claim 1, wherein the support comprises at least two layers, wherein a stack of at least two layers has been formed from electrolyte or non electrolyte polymer layer, or a mixture thereof before penetration of the liquid to the core, then has been swollen by said liquid.

10. The semi-electroactive material as claimed in claim 1, wherein the support comprises three layers, wherein the two outer layers of the stack are layers having low swelling in order to favor the mechanical behavior of said material and the central layer is a layer having high swelling to favor the percolation rate of the ionic charges.

11. The semi-electroactive material as claimed in claim 1, wherein the self-supporting polymer matrix is nanostructured by the incorporation of nanoparticles of fillers or inorganic nanoparticles.

12. A process for manufacturing a semi-electroactive material as defined in claim 1, comprising
mixing polymer granules with a solvent and, if it is desired to manufacture a porous polymer matrix, a pore-forming agent,
casting the resulting formulation on a support, and,
removing the pore-forming agent after evaporation of the solvent by washing in a suitable solvent for example if this agent has not been removed during the evaporation of the aforementioned solvent, the resulting self-supporting film is removed, then said film is impregnated with the solubilization liquid of the semi-electroactive system, and then a draining operation is carried out, where appropriate.

13. A kit for manufacturing the semi-electroactive material as defined in claim 1, comprising:
a self-supporting polymer matrix comprising the semi-electroactive material, wherein the self-supporting polymer matrix comprises at least one polymer layer in which said liquid has penetrated to the core, the polymer comprising at least one layer being a homopolymer or copolymer that is in the form of a nonporous film but is capable of swelling in said liquid, or that is in the form of a porous film, said porous film optionally being capable of swelling in the liquid comprising ionic charges and of which the porosity after swelling is chosen to allow the percolation of the ionic charges into the thickness of the liquid-impregnated film
a solubilization liquid of the semi-electroactive system comprising the semi-semi-electroactive material, wherein the solubilization liquid comprises at least one a solvent or at least one ionic liquid, or at least one ambient-temperature molten salt, or a mixture thereof, said ionic liquid or molten salt then constituting a solubilization liquid bearing ionic charges, which represent all or some of the ionic charges of said semi-electroactive system, liquid bearing ionic charges, which represent all or some of the ionic charges of said semi-electroactive system, wherein the solvent is at least one selected from the group consisting of dimethylsulfoxide, N,N dimethylformamide, N,N dimethylacetamide, propylene carbonate, ethylene carbonate, N methyl-2 pyrrolidone (1 methyl-2 pyrrolidinone), γ-butyrolactone, ethylene glycol, alcohol, ketone, nitrile and water, and the ionic liquid is at least one imidazolium salt selected from the group consisting of-1 ethyl-3 methylimidazolium tetrafluoroborate (emim BF₄), 1 ethyl-3 methylimidazolium trifluoromethane sulfonate (emim CF₃SO₃), 1 ethyl-3 methylimidazolium bis(trifluoromethylsulfonyl)imide (emim N(CF₃SO₂)₂ or emim TSFI) and 1 butyl-3 methylimidazolium bis(trifluoromethylsulfonyl)imide (bmim N(CF₃SO₂)₂ or bmim TSFI), in which said semi-electroactive system has been dissolved.

14. An electrically controllable device having variable optical/energy properties, operating especially in transmission or in reflection, comprising the following stack of layers:
a first substrate having a glass function;
a first electronically conductive layer with an associated current feed;
an electroactive system;
a second electronically conductive layer with an associated current feed; and
a second substrate having a glass function,
the substrates especially being transparent, flat or curved, clear or bulk-tinted, opaque or opacified, of polygonal shape or at least partially curved, and at least one of the substrates possibly incorporating another functionality such as a solar control, antireflection or self-cleaning functionality,
the electroactive system being composed of the following stack of layers:
a semi-electroactive material as defined in claim 1; and
a self-supporting layer of at least one electoactive polymer capable of being reduced or of accepting electrons and cations acting as compensation charges, or both, when the semi-electroactive material comprises at least one electroactive organic compound capable of being oxidized or of ejecting electrons and cations acting as compensation charges, or both, or conversely of at least one electroactive polymer capable of being oxidized or of ejecting electrons and cations acting as compensation charges, or both, when the semi-electroactive material comprises at least one electroactive organic compound capable of being reduced or of accepting electrons and cations acting as compensation charges, or both,
at least one of the electroactive compounds of the semi-electroactive medium and electroactive polymers of the self-supporting layer being electrochromic in order to obtain a color contrast, the ionic charges of said semi-electroactive material, under the action of an electric current, making it possible to reduce or to insert electrons and cations, or both, or to oxidize or to eject electrons and cations in the aforementioned electroactive polymer layer, or both, and the electroactive organic compound of the semi-electroactive medium being oxidized or reduced to obtain a color contrast.

15. The electrically controllable device as claimed in claim 14, wherein the polymer capable of being reduced or of accepting electrons and cations acting as compensation charges is at least one selected from the group consisting of polyviologen, a polymer comprising bipyridinium, pyrylium, pyrazinium or quinoxalium, polyarylene, and polyheteroarylene, and the polymer capable of being oxidized or of ejecting electrons and cations acting as compensation charges, or both, is at least one selected from the group consisting of polyarylamine, polyaniline, polyarylene, polyphenylene, polyfluorene, polyheteroarylene polypyrrole, poly(N sulfonatopropoxy-3,4 propylenedioxypyrrole) (PProDOP NPrS), polyindole, a copolymer of thiophene, poly(octanoic acid 2 thiophen-3 ylethyl ester) (POTE), poly[decanedioic acidbis(2 thiophen-3 ylethyl)ester] (PDATE), poly{2 [(3 thienylcarbonyl)oxy]ethyl 3 thiophene carboxylate} (PTOET), poly{2,3 bis[(3 thienylcarbonyl)oxy]propyl 3 thiophene carboxylate} (PTOPT), poly {3 [(3 thienylcarbonypoxy]-2,2 bis[(3 thienylcarbonyl)oxy]propyl 3 thiophene carboxylate} (PTOTPT), poly[3,6 bis(2 ethylenedioxythienyl)-N methylcarbazole] (PBEDOT NMeCz), polyarylenevinylene, poly(para-phenylene vinylenes) (PPV), polyheteroarylenevinylene, and a polymer comprising ferrocene.

16. The electrically controllable device as claimed in claim 14, wherein said device is configured to form:
a sunroof for a motor vehicle, that can be activated autonomously, or a side window or a rear window for a motor vehicle or a rear view mirror;
a windshield or a portion of a windshield of a motor vehicle, of an aircraft, of a ship, a vehicle sunroof;
an aircraft cabin window;
a glazing unit for cranes, construction site vehicles or tractors;
a display panel for displaying graphical and/or alphanumeric information;
an interior or exterior glazing unit for buildings;
a skylight;
a display cabinet or store counter;
a glazing unit for protecting painting objects;
an anti-glare computer screen;
glass furniture; and
a wall for separating two rooms inside a building.

17. A process for manufacturing the electrically controllable device as defined in claim 14, comprising:
assembling said layers by calendering or laminating optionally with heating, and when the electrically controllable device is intended to constitute a glazing unit, the various layers composing said system are assembled as a single or multiple glazing unit.

18. A single or multiple glazing unit, characterized in that it comprises an electrically controllable device as defined in claim 14.

19. The electrically controllable device as claimed in claim 14, wherein the polyheteroarylene is a polythiophene selected from the group consisting of poly(3,4 ethylenedioxythiophene) (PEDOT), poly[3,3 dimethyl-3,4 dihydro-2H thieno-(3,4 b)dioxepine] (ProDOT Me₂), poly(isothianophthene), polyisothianaphthene (PITN), polyimide, polyquinone and polydisulfide.
